(19) United States
(12) Patent Application Publication
(10) Pub. No.: US 2007/0007184 A1
(43) Pub. Date: Jan. 11, 2007

(54) Specialized sensor-assisted dialysis

(75) Inventors: Andrew M. Voto, Brighton, MI (US); Ronald K. Selby, Flint, MI (US); Kenneth D. Perry, New Lothrop, MI (US); David A. Ross, Columbiaville, MI (US); Alfred V. Dumsa JR., Hartland, MI (US)

Correspondence Address: DELPHI TECHNOLOGIES, INC., M/C 480-410-202, PO BOX 5052, TROY, MI, 48007, US

(73) Assignee: Delphi Technologies, Inc., Troy, MI (US)

(21) Appl. No.: 11/176,746

(22) Filed: Jul. 7, 2005

(51) Int. Cl. B01D 65/00

(52) U.S. Cl. 210/85; 210/96.2; 210/87; 210/321.6

(57) ABSTRACT

The invention is a hemodialysis system in which at least one disposable sensor is combined with a dialysis circuit, in combination with an optional transceiver, to provide real-time or near-real-time patient data. Sensors for any or all of blood pressure, conductivity, temperature, oxygenation, sodium levels, calcium levels, phosphorus levels, urea levels, potassium levels, without limitation, may be included in the blood circuit. Preferably, the sensors are MEMS or ISFET sensors and are positioned in the overall system upstream of, or within the upstream portion of, the dialyzer.

### BACKGROUND OF THE INVENTION

1. Field of the Invention

The invention relates to the specialized incorporation of disposable sensors, such as MEMS-based sensors, into renal dialysis (hemodialysis) equipment of all types, preferably with wireless telemetry of the chemical and physical data collected by the sensors.

2. Description of Related Art

In the mid-1990s, when MEMS (micro-electromechanical systems) were initially widely reported for their promise in various medical applications, it was at first believed that MEMS would have immediate and widespread application in dialysis, infusion and other medical systems. In actual fact, however, the convergence of dialysis, in particular, and MEMS has been slow—and even heretofore nonexistent—for a number of reasons. Certain general disclosure of some MEMS components in dialysis equipment are disclosed, for example, in United States Patent Applications No. 2002/0091350 and No. 2004/0009096. MEMS sensors in particular are not believed to have been incorporated into dialysis systems to date, nor apparently have other disposable sensors been included in new and improved dialysis systems at this writing.

Medical equipment for dialysis is typically made of partly disposable and partly reusable parts. In Europe, at this writing, the “dialyzers” themselves—the machinery which actually comes in contact with the patient's blood and which contain both the dialysis membrane(s) and the dialysate fluids—are typically disposable, whereas in the United States dialyzers are generally cleaned for reuse. Engineering new disposable components into systems that already contain both disposable and reusable segments is always a challenge.

The parameters ideally to be monitored during dialysis of a patient include, without limitation, blood pressure, blood temperature, patient weight as determined by blood volume and flow rates, blood conductivity and blood chemistry monitoring including but not limited to pH and/or to sodium, potassium, phosphorus, calcium, or urea levels. The engineering of dialysis systems to include such a broad range of sensors—whether disposable MEMS sensors or other types of disposable sensors—has apparently not been attempted to date. Presumably dialysis systems and disposable sensors have not heretofore been conjoined due to the perceived extent of the necessary systems modifications, or perhaps because standard length-of-time dialysis protocols are assumed to provide good patient outcome without sophisticated monitoring. Furthermore, as is the case with any medical device modification, challenges persist in creating new components in existing systems without introducing chemical, polymer or other contaminants which, although benign in other settings, cannot be considered to be completely biochemically inert. A need thus remains for a sophisticated system of renal dialysis (hemodialysis) in which at least one and preferably two or more disposable sensors are incorporated in the system as a whole, so as significantly to improve the real-time or near-real-time assessment of the patient's blood before, during and/or after the dialysis procedure.

In the largest sense, a need remains for a monitoring system for human renal dialysis in which blood monitoring is performed in a meaningful, simple, inexpensive, and reliable way.

### SUMMARY OF THE INVENTION

In order to meet this need, the present invention combines at least one disposable sensor in a renal dialysis system with optional wireless telemetry of the data collected by the sensor. (Wired interfaces between the sensor and the dialysis system are embraced by the invention as well.) The disposable sensor is either itself virtually or completely biochemically inert, or is incorporated in the dialysis equipment in an “offline” position with respect to blood flow, or both. In the preferred embodiment of the invention, disposable sensors are provided in the general area upstream, adjacent or within the dialyzer, in position to be contacted by the patient's blood, wherein the sensors are selected to sense a minimum suite of parameters of blood status including flow rate, temperature, pressure, pH, conductivity, or sodium, potassium, calcium, phosphorus, oxygen or urea levels, without limitation. The disposable sensors may be incorporated at any point in the dialysis circuit. The disposable sensors, which may be selected from MEMS or ISFET sensors already well known in the art, must be completely or virtually biochemically inert if they come in contact with the patient's circulating blood. Therefore, a “lab-on-a-chip” type disposable chemical sensor must have all reagents forming a part thereof covalently or otherwise immovably bonded to the sensor substrate and otherwise be made completely of completely inert materials (or be made of materials by which the device is virtually inert (see below)). Other electrochemical sensing technologies known in the art may also be used. Those disposable sensors for which biochemical inertness cannot be verified are positioned offline to the circulating blood. By “offline” is meant “in a diverted portion of blood flow from which the blood is not returned to the patient.” Such sampled blood flow would generally amount to no more blood volume than is typically drawn for routine patient diagnostic purposes. Real-time collection and reporting of the data from all these sensors—most preferably by wireless telemetry—enables perfusionists or other dialysis practitioners to determine optimal length of dialysis treatment on a patient-by-patient basis. Separately, one or more disposable sensors may be supplied to the non-blood side of the dialyzer, to achieve any desired monitoring function including, in particular, the amelioration of cleaning fluid levels during the final rinsing steps of dialyzer cleaning procedures (United States predominantly).

### BRIEF DESCRIPTION OF THE DRAWING(S)

FIG. 1 is a schematic of a renal dialysis circuit that illustrates the positioning of one or more disposable sensors upstream of the dialyzer.

FIG. 2 is a schematic of a renal dialysis circuit which illustrations the position of one or more disposable sensors within the upstream portion of the dialyzer.

FIG. 3 is a schematic of a renal dialysis circuit that illustrates the position of one or more disposable sensors within an offline portion of the dialysis circuit, while the blood pressure disposable sensor remains in contact with the blood to be returned to the patient.

### DESCRIPTION OF THE PREFERRED EMBODIMENT(S)

The present invention combines at least one disposable sensor in a renal dialysis system with optional wireless telemetry of the data collected by the sensor. The disposable sensor is either itself completely biochemically inert, or the disposable sensor is incorporated in the dialysis equipment in an “offline” position with respect to blood flow, or both. By “offline” is meant “in a diverted portion of blood flow from which the blood is not returned to the patient.” A temporary shunt of blood via diverter (such as a stopcock) to a separate offline tube to a housing containing the sensor(s) can accommodate this offline blood analysis for every parameter except, at least optimally, blood pressure. Blood-compatible MEMS or ISFET (or other disposable) biochemically inert blood pressure sensors are already widely available, however, and are therefore generally to be incorporated directly in the path of the patient's circulating blood.

In the preferred embodiment of the invention, disposable sensors are provided in the general area upstream adjacent the dialyzer, or within the upstream portion of the dialyzer, in position to be contacted by the patient's blood. The disposable sensors are selected to assay a minimum suite of parameters of blood status including flow rate, temperature, pressure, pH, sodium, potassium, calcium, phosphorus, oxygen, urea and etc. The disposable sensors may nonetheless be incorporated at any point in the dialysis circuit, even though the positioning of the sensors upstream and/or within the dialyzer is preferred.

The disposable sensors, which may be selected from MEMS or ISFET sensors already in existence at this writing, will be completely or virtually biochemically inert if they come in contact with the patient's circulating blood. Therefore, a “lab-on-a-chip” type disposable chemical sensor will generally have all reagents therein covalently or otherwise immovably bonded to the sensor substrate and be made of biochemically inert materials. Electrochemical sensing technology may also be used. Those disposable sensors for which biochemical inertness cannot be verified are positioned offline to the circulating blood, in sampled blood flow which does not return to the patient. Such sampled blood flow generally amounts to no more blood volume than is typically drawn for routine patient diagnostic purposes. Real-time collection and reporting of the data from all these sensors—most preferably by wireless telemetry—enables perfusionists or other dialysis practitioners to determine optimal length of dialysis treatment.

Separately, one or more disposable sensors may be supplied to the non-blood side of the dialyzer, to achieve any desired monitoring function including, in particular, the status of the elimination of cleaning fluid levels during the final rinsing of dialyzer cleaning procedures (United States predominantly).

“Lab-on-a-chip” type disposable chemical sensors are available commercially. Such “lab-on-a-chip” type disposable chemical sensors typically assay for sodium, potassium, calcium, phosphorus, oxygen and urea levels in dialysis patients but may assay other blood constituents or physical attributes as well. Such chips are often 4×5 millimeter polymer wafers affixed with reagent chemicals and are preferably further provided with means to detect and to transmit the occurrence and/or extent of any chemical reaction which occurs on the chip. Electrochemical sensors may also be used. Detection means may include without limitation any form of spectrometry including but not limited to infrared or mass spectrometry or any other automated means to detect—and to transmit—the occurrence and/or extent of a chemical reaction on the chip. In other words, the chips and the reporting thereof, preferably by wireless means, may collect and transmit data that are both quantitative as well as qualitative. The same detection and transmission means may be used to report data from sensors of physical properties also.

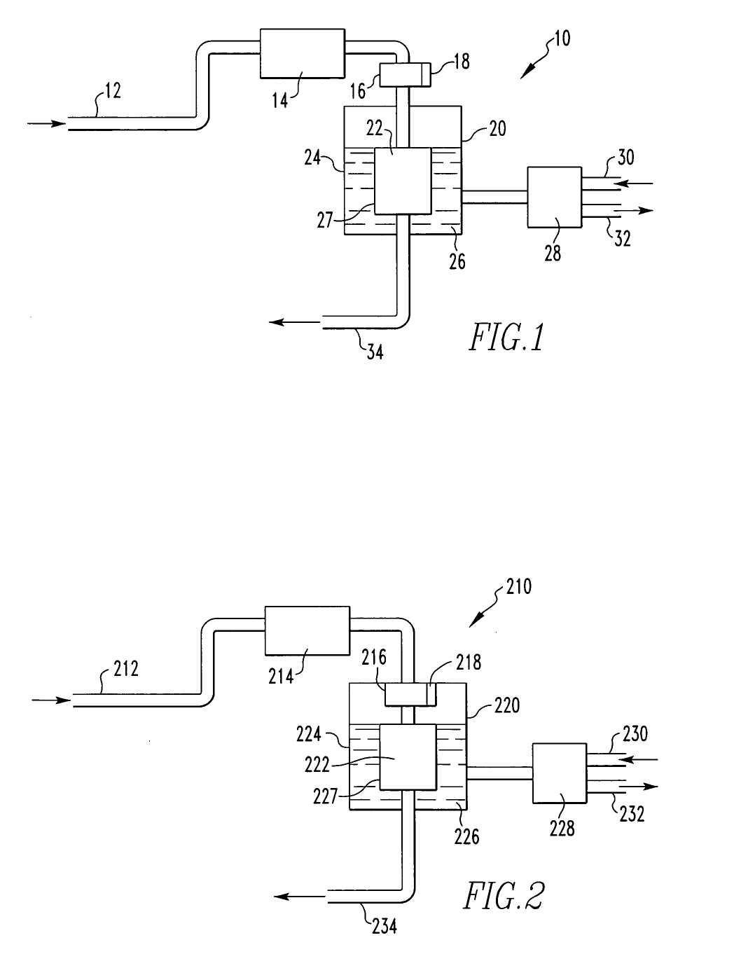

Referring now to FIG. 1, a renal dialysis circuit 10 includes a blood tube inlet 12 to receive patient arterial blood and a pump 14, such as a peristaltic pump, to assist the circulation of the blood throughout the renal dialysis circuit as a whole. Pumps, such as peristaltic pumps, are well known in the dialysis art. Downstream of the pump 14 and upstream of the dialyzer 20 is a disposable sensor unit 16 having an optional transceiver 18 thereon. The disposable sensor unit 16 contains at least one disposable sensor device selected from the group consisting of a blood pressure sensor, a blood temperature sensor, a flow sensor, a calcium sensor, a sodium sensor, a potassium sensor, a chloride sensor, a phosphorus sensor, an oxygen sensor, and a urea sensor. When it is present, the transceiver 18 is equipped to collect data signals from a signal generating means (not shown) in cooperation with the at least one disposable sensor device and to transmit the signals to a patient monitoring location. The dialyzer 20 is, for illustration purposes only, of the annular type in which the blood receptacle 22 is surrounded by an outer chamber 24 designed to contain the dialysate fluid(s) 26 introduced via the dialysate reservoir 28 equipped with dialysate inlet 30 and dialysis outlet 32. The blood receptacle 22 is separated from the dialysate fluid(s) 26 by the dialysis membrane 27. The patient's blood in the blood receptacle 22 eventually returns to the patient's vein via blood tube outlet 34.

FIG. 2 shows a similar renal dialysis circuit 210 as is shown in FIG. 1 except that the disposable sensor unit 216 is formed integrally within the dialyzer 220 and, preferably, at an upstream portion of the interior of the dialyzer 220. In markets in which dialyzers are disposable, the dialyzer 220 containing the disposable sensor unit 216 may be disposed of without disassembly. More particularly as to FIG. 2, a renal dialysis circuit 210 includes a blood tube inlet 212 to receive patient arterial blood and a pump 214, such as a peristaltic pump, to assist the circulation of the blood throughout the renal dialysis circuit. Housed within the outer chamber 224 of the dialyzer 220 is a disposable sensor unit 216 having an optional transceiver 218 thereon. The disposable sensor unit 216 contains at least one disposable sensor device selected from the group consisting of a blood pressure sensor, a blood temperature sensor, a flow sensor, a pH sensor, a conductivity sensor, a calcium sensor, a sodium sensor, an oxygen sensor a potassium sensor, a chloride sensor, a phosphorus sensor, and a urea sensor. When it is present, the transceiver 218 is equipped to collect data signals from a signal generating means (not shown) in cooperation with the at least one disposable sensor device and to transmit the signals to a patient monitoring location. The dialyzer 220 is, for illustration purposes only, of the annular type in which the blood receptacle 222 is surrounded by an outer chamber 224 designed to contain the dialysate fluid(s) 226 introduced via the dialysate reservoir 228 equipped with dialysate inlet 230 and dialysis outlet 232. The blood receptacle 222 is separated from the dialysate fluid(s) 226 by the dialysis membrane 227. The patient's blood in the blood receptacle 222 eventually returns to the patient's vein via blood tube outlet 234.

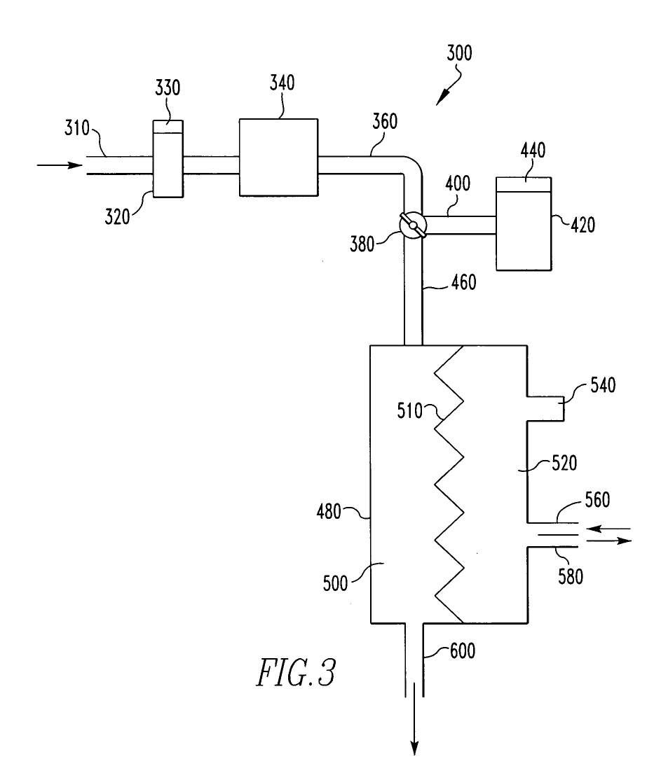

Referring now to FIG. 3, a portion of a renal dialysis circuit 300 is shown in which a disposable blood pressure sensor 320 is equipped with an optional transceiver 330 immediately downstream of the patient arterial blood tube inlet 310. This positioning of the blood pressure sensor 320 allows assessment (and optionally transmission) of the patient's blood pressure from a position generally adjacent the patient's body. The circulating blood passes from the blood pressure sensor 320 to the pump 340, and through the blood tube 360 to a diverter 380. At the diverter 380, blood may at the perfusionist's or other operator's direction enter the dialyzer 480 or be temporarily diverted via diverter tube 400 to the disposable sensor unit 420 having an optional transceiver 440 therein. The disposable sensor unit 420 contains at least one disposable sensor device selected from the group consisting of a blood temperature sensor, a flow sensor, a conductivity sensor, a pH sensor, a calcium sensor, a sodium sensor, a potassium sensor, a chloride sensor, a phosphorus sensor, an oxygen sensor and a urea sensor. When it is present, the transceiver 440 is equipped to collect data signals from a signal generating means (not shown) in cooperation with the at least one disposable sensor device and to transmit the signals to a patient monitoring location. When blood flow is returned to the dialyzer 480 via dialyzer tube 460, the blood enters the blood chamber 500 where it is separated from the dialysate chamber 520 by the dialysis membrane 510. Dialysate fluids enter and exit the dialysate chamber 520 via dialysate inlet 560 and dialysate outlet 580. An optional additional disposable sensor (or two or more sensors) are provided in communication with the dialysate chamber 520 in the sensor chamber 540. Primarily, a disposable sensor in sensor chamber 540 would be used to monitor the removal of cleaning fluids in the dialysate side of the dialyzer 480, when the dialyzer 480 is cleaned for reuse. Other disposable sensors, without limitation, may also be included in the sensor chamber 540. Ultimately, the patient's blood (venous return) is returned to the patient via venous blood tube outlet 600.

It should be borne in mind that disposable flow sensors according to the present invention allow direct measurement of flow rates, instead of being calculated from other indirect parameters, and can also allow for closed loop controlled operation. At this writing, most pumps on hemodialysis machines are operated “open loop,” relying on initial calibration of the pump, and assumes no tubing tolerance, pump slippage or other such problems. With a closed loop system, accuracies are improved, and the pump will have a longer operating life since any wear on the machine can be compensated for through the feedback from the flow sensor. One additional benefit of a closed loop system as it relates to flow control of the ultra-filtration pump is the elimination or minimization of the effects of intermittent flow which typically result in higher peak concentrations of solutes and a greater time-averaged concentration of urea. The benefit to the patient is less uremic (lower toxin) levels, which result in reduced fluid retention, improved patient outcomes and a higher quality of life.

It is possible to depart from the above-described exemplary Figures without departing from the scope of the present invention. The same sensors as described above, plus conductivity sensors or other chemical sensors of virtually any type, may be incorporated in patient infusion systems as well as dialysis systems under the same general guidelines. The same set of sensors may be provided, if desired, on both the blood and the dialysate sides of a dialyzer in order to coordinate constituent types and amounts in the dialysate fluid, for example. Pressure sensors other than strict blood pressure sensors also have utility in the present context. For example, a pressure sensor anywhere in the circuit can identify problems such as occlusions, disconnected lines, clogged equipment, and etc. Also, any dialysate sensors may be used if they promote the matching of ion or other blood constituents vis a vis the blood, for constituents which should not be removed from the blood and which are permeable to the membrane. Along this conceptual line it should also be noted that, strictly speaking, the disposable sensors do not have to be completely biochemically inert, in order to justify their contacting the circulating blood of the patient as “virtually biochemically inert” components. Any xenogenic chemical released by one or more of the disposable sensors and that is permeable to the dialysis membrane can be removed by the dialysis process and will not be returned to the patient, thus rendering the sensor virtually biochemically inert. This ability to cleanse the blood of any impurity introduced by the sensor is one reason why the preferred location of the disposable sensor(s) is upstream of the dialyzer, or at least in the upstream portion of the dialyzer.

A clear advantage of the present system is that when multiple real-time sensing of dialysis parameters is provided, patient care is optimized on a patient-by-patient basis, rather than treating patients according to typical or standardized treatment norms. This customized patient care is not just a luxury but can in many cases determine the life or death of the patient. For example, most renal dialysis patients do not have a stable level of renal function, but often have renal (and related) function(s) which continue to decline over time. A patient who can tolerate a break from dialysis from, say, Friday to Monday in a given month may be unable to tolerate such a break a month or two thereafter, with such intolerance possibly resulting in death. With the particularized sensing and reporting possible with the present system, decreased renal function becomes apparent with increased treatment times as determined by the sensor data, so that the perfusionist or other practitioner knows without speculating when dialysis times or repetitions need to be increased.

Although the invention has been described with particularity above, in reference to particular components, blood parameters, structures and methods, the invention is only to be considered to be limited insofar as it is set forth in the accompanying claims.

1. A hemodialysis system, comprising:
a blood circuit tube having an interior;
a dialyzer in fluid communication with the interior of the blood circuit tube; and
not more than one substantially biochemically inert disposable sensor unit including at least one disposable sensor device in fluid communication with the interior of the blood circuit tube, wherein the at least one disposable sensor device is configured to sense one or more physical or chemical parameters of contents of the blood circuit tube; wherein the not more than one substantial biochemically disposable sensor unit is operatively placed one of: upstream of the dialyzer; or within the dialyzer.

2. The hemodialysis system according to claim 1 wherein the at least one disposable sensor device is selected from the group consisting of a blood pressure sensor, a conductivity sensor, a temperature sensor, a flow sensor, an oxygen sensor, a sodium sensor, a calcium sensor, a potassium sensor, a phosphorus sensor, a pH sensor, and a contaminant sensor.

3. The hemodialysis system according to claim 2 wherein the substantially biochemically inert disposable sensor unit is selected from the group consisting of a MEMS (micro electromechanical systems) sensor and an ISFET sensor.

4. (canceled)

5. The hemodialysis system according to claim 1 wherein the substantially biochemically inert disposable sensor unit is operatively placed within the dialyzer, and wherein the sensor unit is further positioned in an upstream portion of the dialyzer.

6. The hemodialysis system according to claim 2, further comprising a diverter blood tube including the substantially biochemically inert disposable sensor unit, the diverter blood tube being in fluid communication with the blood circuit tube, and the diverter blood tube configured to receive a discrete portion of the contents of the blood circuit tube, the discrete portion substantially withheld from the dialyzer.

7. The hemodialysis system according to claim 1, further comprising a disposable blood pressure sensor in fluid communication with the blood circuit tube and positioned upstream of the substantially biochemically inert disposable sensor unit.

8. The hemodialysis system according to claim 1, further comprising means, operatively connected to the substantially biochemically inert disposable sensor unit, for transmitting data representative of the one or more physical or chemical parameters by wireless telemetry.

9. A dialyzer for renal dialysis, comprising a housing and at least one dialysis membrane, wherein the housing has not more than one substantially biochemically inert disposable sensor unit mounted one of: adjacent to and upstream from the housing; or within the housing.

10. The dialyzer according to claim 9, wherein the substantially biochemically inert disposable sensor unit is mounted within the housing.

11. The hemodialysis system according to claim 1 wherein the substantially biochemically inert disposable sensor unit is operatively placed upstream of the dialyzer.

12. The hemodialysis system according to claim 1 wherein the at least one disposable sensor device is configured to take direct measurements of the one or more physical or chemical parameters.

13. The hemodialysis system according to claim 1 wherein the at least one disposable sensor device is configured to facilitate closed loop controlled operation.
